(19) United States
(12) Patent Application Publication
(10) Pub. No.: US 2008/0144900 A1
(43) Pub. Date: Jun. 19, 2008

(54) Fast self-calibrating radial sensitivity encoded image reconstruction using rescaling and preconditioning

(75) Inventors: Debiao Li, Naperville, IL (US); Jaeseok Park, Baiersdorf (GE); Andrew C. Larson, Kildeer, IL (US)

Correspondence Address: SCHIFF HARDIN, LLP;PATENT DEPARTMENT, 6600 SEARS TOWER, CHICAGO, IL, 60606-6473, US

(73) Assignee: Northwestern University

(21) Appl. No.: 11/585,424

(22) Filed: Oct. 23, 2006

(51) Int. Cl. G06K 9/00

(52) U.S. Cl. 382/130

(57) ABSTRACT

In a magnetic resonance imaging method and apparatus, sensitivity encoding (SENSE) with radial sampling trajectories combines the gridding principle with conjugate-gradient least-squares (CGLS) iterative reconstruction. Radial k-space is mapped to a larger matrix by a resealing factor to eliminate the computational complexity of conventional gridding and density compensation. To improve convergence rate of high spatial frequency signals in CGLS iteration, a spatially invariant de-blurring k-space filter uses the impulse response of the system. This filter is incorporated into the SENSE reconstruction as preconditioning. The optimal number of iterations represents a tradeoff between image accuracy and noise over several reduction factors.

### FEDERAL FUNDING LEGEND

This invention was produced in part using funds from the Federal government under NIH Grant Nos. HL38698 and EB002623. Accordingly, the Federal government has certain rights in this invention.

### BACKGROUND OF THE INVENTION

1. Field of the Invention

The present invention concerns a method and apparatus for reconstructing an image from acquired magnetic resonance data, in particular magnetic resonance imaging data acquisition using parallel imaging techniques.

2. Description of the Prior Art

Recently developed parallel imaging techniques, using arrays of multiple receiver coils, accelerate MRI data acquisition. This acceleration is achieved by under-sampling k-space as compared to conventional acquisition. Aliasing artifacts resulting from the under-sampling of k-space can be removed by exploiting the knowledge of spatial coil sensitivity. Therefore, coil calibration in either the image domain or k-space is required for parallel imaging reconstruction.

Image domain-based coil calibration has been performed using a variable-density (VD) sampling scheme in a single measurement (McKenzie et al, “Self-Calibrating Parallel Imaging with Automatic Coil Sensitivity Extraction,” “Magn Reson Med 2002;47(3):529-538) or a low-resolution image acquired during a separate scan prior to accelerated imaging data acquisition Pruessmann et al. “SENSE: Sensitivity Encoding for Fast MRI,” Magn Reson Med 1999;42(5):952-962). The former extracts a low-frequency k-space with zero padding followed by Fourier-transform, yielding a low-resolution image for calibration. This is advantageous in preserving consistency between coil calibration and imaging data. However, this technique requires the acquisition of extra reference signals in the central k-space, placing limits on achievable spatial and/or temporal resolution. The latter eliminates the need to acquire extra reference signals during accelerated data acquisition, but is susceptible to calibration errors since it does not ensure that coil and imaging slice remain exactly at the same position between calibration and imaging scans. For both of these image based coil calibration schemes, a large field-of-view (FOV) is commonly required, since wrap-around artifacts resulting from a small FOV cause erroneous estimation of coil sensitivity. This places another limit upon achievable spatial resolution, particularly, for the aforementioned method described by McKenzie et al.

K-space based coil calibration (Griswold et al, “Generalized Autocalibrating Partially Parallel Acquisitions (GRAPPA),” Magn Reson Med 2002;47(6):1202-1210) conventionally employs the VD sampling scheme, extracting calibration information from additionally sampled reference and its neighborhood signals in the central region of k-space. This technique allows a small FOV in data acquisition, because coil calibration does not refer to information in the image domain. However, the extra reference signals still need to be acquired, requiring additional acquisition time.

An alternative method to overcome the limitations of coil calibration in parallel imaging is to employ a radial k-space sampling scheme. Radial sampling trajectories provide inherent over-sampling in the central region of k-space, conceptually equivalent to VD sampling without collecting extra reference signals. Streak artifacts typically result from the deviation of the Nyquist sampling rate in the outer region of radial k-space. Exploiting only the over-sampled central region of radial k-space can eliminate the streak artifacts in coil calibration. Therefore, coil calibration is nearly independent of FOV in data acquisition. The recently proposed sensitivity encoding (SENSE) technique (Pruessmann et al, “Advances in Sensitivity Encoding with Arbitrary k-space Trajectories,” Magn Reson Med 2001;46(4):638-651) is capable of utilizing the advantages of radial sampling trajectories in coil calibration, combining the gridding principle with conjugate-gradient least squares (CGLS) iterative reconstruction. However, the gridding operation is computationally expensive, and requires highly accurate density compensation (Rasche et al. “Resampling of Data Between Arbitrary Grids Using Convolution Interpolation,” IEEE Trans Med Imaging 1999;18(5):385-392). In CGLS iteration, high spatial frequency signals converge slowly and noise is gradually amplified due to increasing rounding errors (Hansen Rank-Deficient and Discrete III-posed Problems: Numerical Aspects of Linear Inversion, “Philadelphia: Siam; 1998. xvi, 247 p).

### SUMMARY OF THE INVENTION

An object of the present invention is to provide SENSE reconstruction technique combined with resealing and preconditioning, that eliminates the computational complexity of gridding and density compensation as well as improving the convergence rate of CGLS iteration.

The above object is achieve in accordance with the present invention wherein the SENSE technique is combined with the gridding principle of CGLS iterative reconstruction, using resealing and preconditioning techniques for radial sampling trajectories. To eliminate the computational complexity of conventional gradient and density compensation, in accordance with the invention, radial k-space is simply mapped to a larger, rectilinear matrix by a resealing factor. Thereafter, all procedures in CGLS SENSE are performed in the rectilinear grid, removing the need to resample measured radial sampling trajectories during iterations, as in conventional SENSE reconstruction. To improve the convergence rate of high spatial frequency signals in the CGLS iteration, a spatially invariant de-blurring k-space filter is designed, using the impulse response of the system. This filter is incorporated into the SENSE reconstruction as preconditioning.

The invention speeds up SENSE image reconstruction, making it feasible for use in clinical scanners with a variety of applications that require high temporal and/or spatial resolution. The inventive radial SENSE implementation is more efficient than conventional SENSE, because it eliminates the need of a separate scan for coil calibration using the over-sampled central radial k-space, and it relieves the computational load of conventional gradient and density compensation, and the convergence rate of the CGLS iteration is enhanced using a simple image de-blurring method. The benefits of the invention apply also to arbitrary k-space trajectories, such as spiral and PROPELLER sampling techniques.

### DESCRIPTION OF THE DRAWINGS

FIG. 1 schematically illustrates a magnetic resonance tomography apparatus operable in accordance with the present invention.

FIG. 2 schematically illustrates CGLS SENSE reconstruction using resealing and preconditioning, in accordance with the present invention.

FIG. 3A shows the point spread function (PSF) of the E^{HE} operation, and FIG. 3B shows the corresponding de-blurring k-space filter, for a radial sampling trajectory (R=2, r=2).

FIG. 4 shows the relation between reconstruction time and the reduction factor R in CGLS SENSE reconstruction for a single iteration, using conventional gridding and resealing (r=2) techniques.

FIG. 5A shows the effect of the resealing factor on CGLS SENSE reconstruction (R=3), showing image error with respect to the number of iterations, FIG. 5B shows an image (b) reconstructed using conventional gridding, and images (c), (d) and (e) respectively reconstructed using CGLS SENSE with three different resealing factors (r=1, 2 and 3), and N^{iter}=20.

FIG. 6 shows images (a) reconstructed with CGLS SENSE with resealing for radial sampling trajectories (R=2, r=2) using no preconditioning, and images (b), (c) and (d) with preconditioning with α=0.0001, preconditioning with α=0.05, and preconditioning with α=0.08, respectively.

FIG. 7 shows the relationship between image error and number of iterations in CGLS SENSE reconstruction (R=2, r=2) with no preconditioning, and preconditioning with α=0.001, preconditioning with α=0.05, and preconditioning with α=0.8.

FIG. 8A shows the relationship between deviation error and number of iterations, and FIG. 8B shows the relationship between image error and number of iterations, in CGLS SENSE reconstruction with rescaling and preconditioning (r=2, α=0.05) with increasing R.

FIG. 9 shows cardiac images (a) reconstructed using conventional gridding for different radial sampling trajectories, and cardiac images (b) reconstructed with CGLS SENSE with resealing and preconditioning (r=2, α=0.05) for the same different radial sampling trajectories.

### DESCRIPTION OF THE PREFERRED EMBODIMENTS

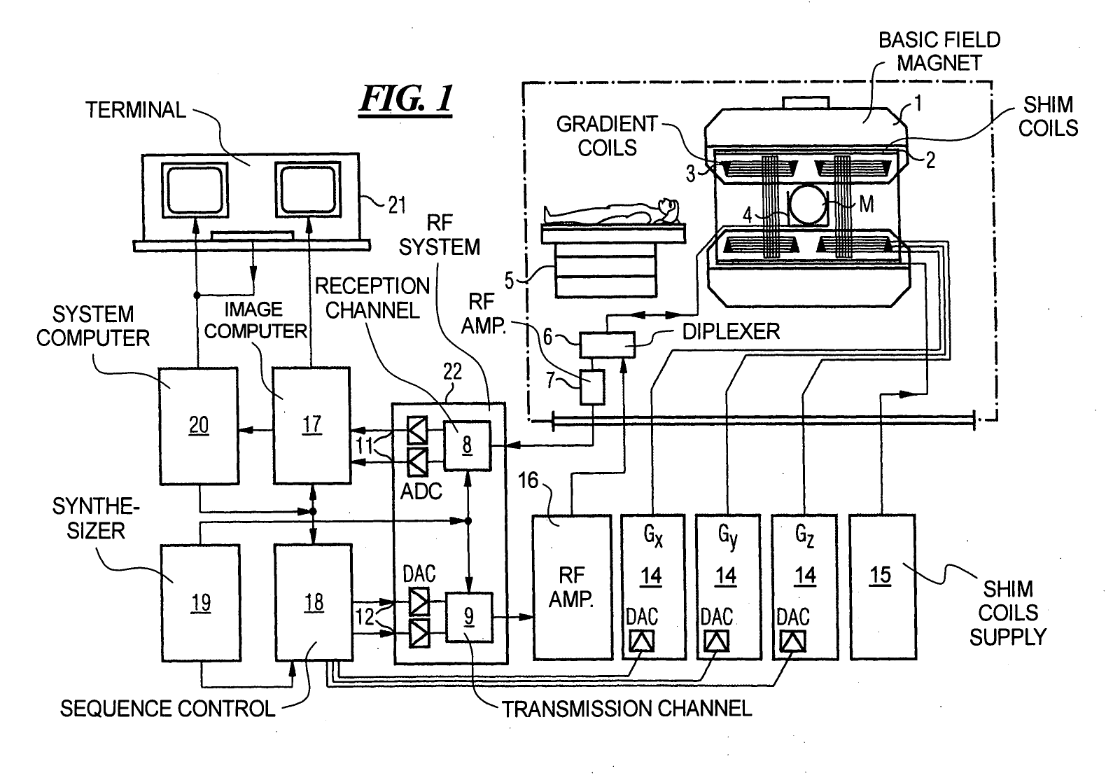

FIG. 1 is a schematic illustration of a magnetic resonance tomography apparatus operable according to the present invention. The structure of the magnetic resonance tomography apparatus corresponds to the structure of a conventional tomography apparatus, with the differences described below. A basic field magnet 1 generates a temporally constant, strong magnetic field for the polarization or alignment of the nuclear spins in the examination region of a subject such as, for example, a part of a human body to be examined. The high homogeneity of the basic magnetic field required for the magnetic resonance measurement is defined in a spherical measurement volume M into which the parts of the human body to be examined are introduced. For satisfying the homogeneity requirements and, in particular, for eliminating time-invariable influences, shim plates of ferromagnetic material are attached at suitable locations. Time-variable influences are eliminated by shim coils 2 that are driven by a shim power supply 15.

A cylindrical gradient coil system 3 that is composed of three sub-windings is introduced into the basic field magnet 1. Each sub-winding is supplied with current by an amplifier 14 for generating a linear gradient field in the respective direction of the Cartesian coordinate system. The first sub-winding of the gradient field system generates a gradient Gₓ in the x-direction, the second sub-winding generates a gradient G_{y} in the y-direction and the third sub-winding generates a gradient G_{z} in the x-direction. Each amplifier 14 has a digital-to-analog converter that is driven by a sequence controller 18 for the temporally correct generation of gradient pulses.

A radio frequency antenna 4 is situated within the gradient field system 3. This antenna 4 converts the radio frequency pulse output by a radio frequency power amplifier 30 into a magnetic alternating field for exciting the nuclei and alignment of the nuclear spins of the examination subject or of the region of the subject to be examined. The antenna 4 is schematically indicated in FIG. 1. For acquiring magnetic resonance data according to a PPA technique, the antenna 4 is a coil array formed by multiple individual reception coils. The antenna 4 can include a different coil for emitting the RF signals into the subject.

The radio frequency antenna 4 and the gradient coil system 3 are operated in a pulse sequence composed of one or more radio frequency pulses and one or more gradient pulses. The radio frequency antenna 4 converts the alternating field emanating from the precessing nuclear spins, i.e. the nuclear spin echo signals, into a voltage that is supplied via an amplifier 7 to a radio frequency reception channel 8 of a radio frequency system 22. The radio frequency system 22 also has a transmission channel 9 in which the radio frequency pulses for exciting the nuclear magnetic resonance are generated. The respective radio frequency pulses are digitally represented as a sequence of complex numbers in the sequence controller 18 on the basis of a pulse sequence prescribed by the system computer 20. As a real part and an imaginary part, this number sequence is supplied via an input 12 to a digital-to-analog converter in the radio frequency system 22 and from the latter to a transmission channel 9. In the transmission channel 9, the pulse sequences are modulated onto a high-frequency carrier signal having a base frequency corresponding to the resonant frequency of the nuclear spins in the measurement volume.

The switching from transmission mode to reception mode ensues via a transmission-reception diplexer 6. The radio frequency antenna 4 emits the radio frequency pulses for exciting the nuclear spins into the measurement volume M and samples resulting echo signals. The correspondingly acquired nuclear magnetic resonance signals are phase-sensitively demodulated in the reception channel 8 of the radio frequency system 22 and converted via respective analog-to-digital converters into a real part and an imaginary part of the measured signal. An image computer 17 reconstructs an image from the measured data acquired in this way. The management of the measured data, of the image data and of the control programs ensues via the system computer 20. On the basis of control programs, the sequence controller 18 controls the generation of the desired pulse sequences and the corresponding sampling of k-space. In particular, the sequence controller 18 controls the temporally correct switching of the gradients, the emission of the radio frequency pulses with defined phase and amplitude as well as the reception of the magnetic resonance signals. The time base (clock) for the radio frequency system 22 and the sequence controller 18 is made available by a synthesizer 19. The selection of corresponding control programs for generating a magnetic resonance image as well as the presentation of the generated magnetic resonance image ensue via a terminal 21 that has a keyboard as well as one or more picture screens.

The apparatus shown in FIG. 1 operates in accordance with the present invention by virtue of an appropriate pulse sequence (protocol) being entered by an operator via the terminal 22 into the system computer 20 and the sequence control 18.

SENSE reconstruction is generalized to the following linear matrix equation (Pruessmann et al, “Advances in Sensitivity Encoding with Arbitrary k-space Trajectories,” Magn Reson Med 2001;46(4):638-651):

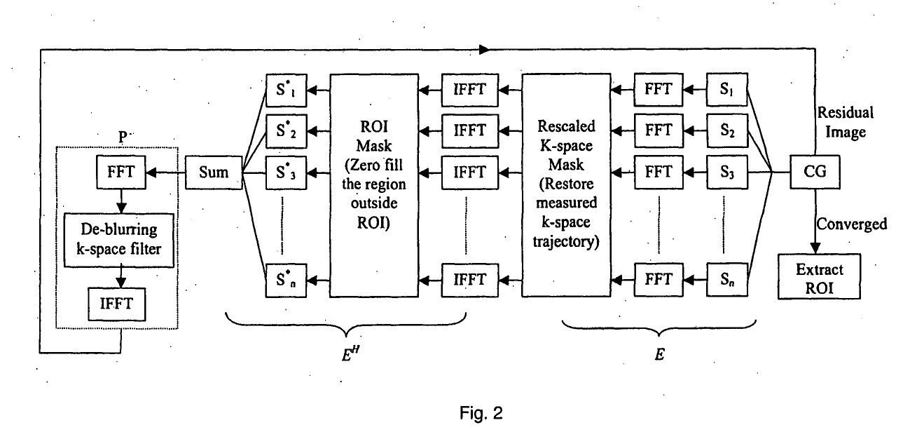

E^{H} Ex=E^{H} m [1]

where E is an encoding matrix, E^{H} is its Hermitian matrix, m is a measured radial k-space matrix, and x is a reconstructed image. Equation [1] is solved using CGLS iteration with forward and reverse gridding between rectilinear and radial k-space trajectories. Density compensation is applied before radial k-space is transformed to a rectilinear grid by convolution (Rasche et al, “Resampling of Data Between Arbitrary Grids Using Convolution Interpolation,” “IEEE Trans Med Imaging 1999;18(5):385-392). However, conventional gridding operates pixel-by-pixel, and is computationally expensive. An accurate density compensation function also needs to be determined to avoid image distortion. Additionally, CGLS iteration can be viewed as a regularization method because low spatial frequency signals converge much faster than high spatial frequency signals (Hansen, “Rank-deficient and Discrete III-posed Problems: Numerical Aspects of Linear Inversion,” Philadelphia: Siam; 1998. xvi, p. 247). The intrinsic regularizing effect results in slow recovery of image details as well as gradual noise amplification due to rounding errors increasing with iterations. To overcome the aforementioned limitations, in accordance with the invention CGLS SENSE reconstruction is performed, combining resealing (Oesterle et al, “Spiral Reconstruction by Regridding to a Large Rectilinear Matrix: A Practical Solution for Routine Systems,” J Magn Reson Imaging 1999;10(1):84-92) and preconditioning (Clinthorne et al, “Preconditioning Methods for Improved Convergence Rates in Iterative Reconstructions,” IEEE Trans Med Imaging 1993;12(1):78-83) methods. An overall schematic of the inventive implementation is shown in FIG. 2.

To simplify the gridding process in SENSE reconstruction, in accordance with the invention the resealing method is incorporated into CGLS iteration, eliminating convolution and density compensation (FIG. 2). Radial k-space is expanded to an rN×rN matrix (N: number of readout sampling) by a scaling factor of r by rounding off a restated coordinate to the nearest rectilinear grid location. If several points in radial k-space are mapped onto the same coordinate, their mean values are calculated. The rescaled k-space mask in FIG. 2 is generated by setting the rescaled sample positions to ones and all other positions to zeros. Utilization of a large resealing factor approximates a convolution function to a delta function for conventional gridding. The approximation enables convolution to be performed by simply mapping measured radial k-space to its rescaled matrix. The de-convolution procedure necessary for conventional gridding is eliminated, because the Fourier transform of a delta function is a constant.

To calculate coil sensitivity (Sₙ:n=coil index) in FIG. 2, the central region of the rescaled k-space is extracted and followed by zero padding (i.e. the area outside the R01 is filled with zeroes). The zero padded low-frequency k-space at each coil is inverse Fourier transformed (IFFT), resulting in a low-resolution image without streak artifacts. Each coil image is normalized by the root sum of squared magnitudes of all the coil images, generating coil sensitivity.

In the E^{H} process in Eq. [1], each rescaled coil k-space is processed by IFFT, generating a reconstructed image in the central N×N region and severe aliasing artifacts outside of it. A region-of-interest (ROI) mask is constructed with ones in the central N×N region and zeros outside of it. The ROI mask is multiplied to each coil image, replacing the aliased outer region with zeros while preserving the central image region. The processed image is multiplied by the corresponding complex conjugate of coil sensitivity image (Sₙ*). The respective coil images are then summed.

In the E process in Eq. [1], a residual image undergoes the multiplication of coil sensitivity followed by FFT, resulting in rescaled coil k-space. The coil k-space is updated by multiplication by the pre-calculated rescaled k-space mask. This process restores the measured radial sampling trajectories rescaled to the rectilinear grids.

Once the right side of Eq. [1], E^{H} m, is initialized, a residual image CG (rN×rN) is multiplied by E^{H} E during iterations. Considering the intrinsic regularizing effect of CGLS, the number of iterations needs to be estimated to achieve an optimal tradeoff between image accuracy and noise. Since a CGLS loop stops at the presumed optimal number of iterations, a final image needs to be cropped to extract the central N×N image. This is because the resealing process is equivalent to the sub-sampling of measured data, resulting in a larger FOV than that provided by the originally sampled data. IT is notable that all the procedures are performed in the rescaled rectilinear grids, eliminating the need to resample radial sampling trajectories as in conventional SENSE reconstruction.

The convergence rate of CGLS iteration is limited by an intrinsically slow convergence rate of high spatial frequency signals and large deviation of the initial image (=E^{H} m) of Eq. [1] from the solution of the linear system. Density compensation was completely removed over the entire process in the previous section. Initializing E^{H} m in Eq. [1] without k-space density compensation results in a highly blurred image due to heavily weighted low-frequency signals. As a result, the initial image in CGLS iteration is largely deviant from the solution when the resealing method is employed.

To resolve the above limitations simultaneously, in accordance with the invention, image de-blurring is applied to both sides of Eq. [1] as a preconditioning step:

PE^{H} EX=PE^{H} m [2]

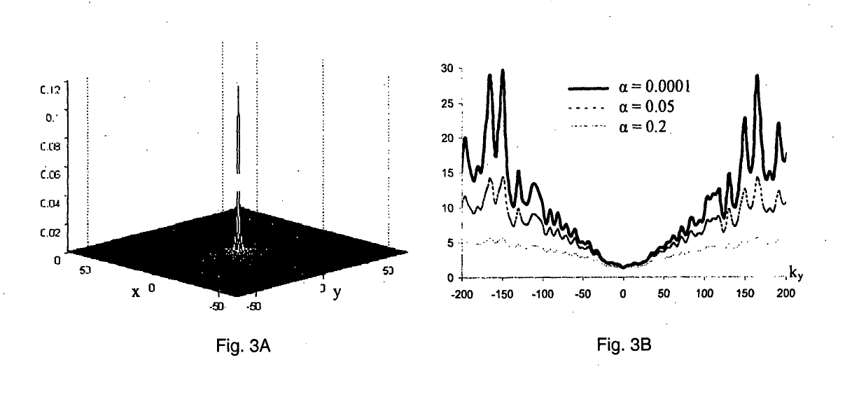

P=F*MF [3]

where P is a preconditioning matrix, F is a two-dimensional (2D) discrete FFT matrix, M is a diagonal matrix containing image de-blurring information, and F * is a complex conjugate of F. The P operation in Eq. [3] is composed of three steps as shown in FIG. 2: 1) FFT, 2) application of a de-blurring k-space filter, and 3) IFFT. To design the k-space filter, a point spread function (PSF) of the E^{H} E operation is first generated by projecting a point source located at the center of the rescaled matrix (rN×rN) for measured radial k-space trajectories. The PSF is then Fourier transformed to a frequency domain. Assuming the PSF is spatially invariant, the k-space filter to de-convolve the calculated PSF is generated. The process is summarized as:

$$\begin{matrix}PSF = {E}^{H} E δ ( 0 , 0 ) & [ 4 ] \\ H ( {k}_{x} , {k}_{y} ) = FFT ( PSF ) & [ 5 ] \\ M ( {k}_{x} , {k}_{y} ) = \frac{1}{\vert H ( {k}_{x} , {k}_{y} ) \vert + α * max ( \vert H \vert )} & [ 6 ]\end{matrix}$$

where δ is a delta function, H(kₓ,k_{y}) is the FFT of the PSF, M(kₓ,k_{y}) is the de-blurring k-space filter, max is a function to yield a maximum value of an input, and a is a constant to limit the effect of filter. FIGS. 3a and 3b represent the PSF of the measured radial sampling trajectories (R=2, r=2) (FIG. 3a) and the 1D profile of the M(kₓ,k_{y}) with α=0.0001, 0.05, and 0.2 (FIG. 3b). As α is increased, the effect of high-pass filtering is decreased. Since the preconditioning simply restores the impulse response of SENSE operation, positive-definiteness of Eq. [2] required for CGLS iteration is preserved. In addition, the de-blurred initialized image, PE^{H} m, in Eq. [2] is closer to the solution of the linear system than E^{H} m in Eq. [1], representing favorable preconditioning.

All imaging experiments for assessing the efficacy of the inventive method and apparatus were performed in a phantom and a volunteer on a 1.5 T whole body MR scanner (MAGNETOM Sonata, Siemens Medical Solutions, Erlangen, Germany) equipped with a high performance gradient sub-system (maximum amplitude: 40 mT/m, maximum slew rate: 200 mT/m/ms). A commercially available 6-element phase array cardiac coil (rectangular dimension: 11×12 cm²) was placed anterior to each subject. The rectangular coils were overlapped to null the mutual inductance between neighboring coil elements. Image reconstruction was implemented in Matlab (MathWorks, Natick, Mass.).

A set of data was acquired in a phantom using radial sampling trajectories. A 2D steady state free precession (SSFP) sequence was used. Imaging parameters were as follows: TR (time of repetition)/TE (time of echo)/flip angle=2.8 ms/1.4 ms/50°, FOV=300×300 mm², number of acquired views=128, number of readout sampling=128 (over-sampled to be 256), number of slice=2, and slice thickness=6 mm. For SENSE reconstruction, the fully acquired data was decimated by a reduction factor (R).

Reconstruction time in SENSE was measured on a Pentium-IV 3 GHz processor system for a single iteration using both the conventional gridding and resealing (r=2) methods for comparison as R is increased from one to six. In the conventional gridding, a 3×3 Kaiser-Bessel convolution function was employed with density compensation using a Voronoi diagram. To demonstrate the effect of the resealing factor on SENSE reconstruction, the image error (=Δ) for an ROI was calculated for r=1, 2, and 3 at R=3 as the number of iterations (N^{iter}) was increased:

$$Image Error ( = Δ ) = {\sum }_{j} \vert {\vert x \vert}_{j} - {\vert {I}^{REF} \vert}_{j} \vert \qquad [ 7 ]$$

where j is a pixel index, x is a residual image at each iteration, and I^{REF} is a reference image reconstructed by SENSE with the resealing method (R=1, r=3, N^{iter}=10). The image reconstructed by the conventional gridding method was compared with the images generated by SENSE reconstruction with r=1, 2, and 3 when N^{iter} is 20.

To investigate the effect of the image de-blurring on SENSE reconstruction with the resealing method (R=2, r=2), image progression was demonstrated with and without the preconditioning over the first several iterations. The preconditioning was performed with α=0.0001, 0.05, and 0.8 in Eq. [4]. The image error with iterations was also measured to evaluate convergence rate.

Additionally, a set of cardiac image data was acquired for a healthy volunteer with radial sampling trajectories. An ECG triggered 2D cine segmented SSFP sequence was used for data acquisition during a single breath-hold. Imaging parameters were: TR/TE/flip angle=2.8 ms/1.4 ms/50°, FOV=300×300 mm², number of acquired views=128, number of readout sampling=128, number of slice=1, slice thickness=6 mm, number of cine phases=16, and number of acquired views/cine phase=16. The fully acquired data was decimated by a reduction factor to simulate accelerated data acquisition. Convergence rate of CGLS SENSE reconstruction with both the resealing and preconditioning methods (r=2, α=0.05) was investigated with the increase of R by calculating the deviation error (=δ) with iterations:

$$Deviation error ( = δ ) = \frac{{\sum }_{j} \vert {\vert {PE}^{H} Fx \vert}_{j} - {\vert {PE}^{H} m \vert}_{j} \vert}{{\sum }_{j} {\vert {PE}^{H} m \vert}_{j}} \qquad [ 8 ]$$

This deviation error represents the distance of an intermediate solution from the initial image on the right side of Eq. [2]. The image error (=Δ) in Eq. [7] was also calculated with iterations as R was increased. The number of iterations required for SENSE reconstruction was determined as the image error was near its minimal value and image quality was no longer improving. The images reconstructed using the proposed SENSE with the predetermined N^{iter} were compared with those generated using the conventional gridding at R=2, 3, 4, and 6.

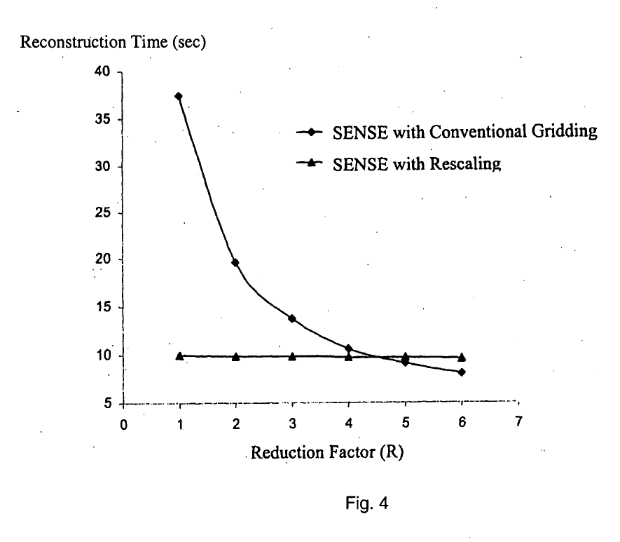

The results of the phantom experiment are illustrated in FIGS. 4, 5A-5B, and 6.

FIG. 4 shows the reconstruction time for CGLS SENSE for a single iteration using the conventional gridding and proposed resealing methods, respectively. As R is increased, SENSE reconstruction time with the conventional gridding decreases rapidly, but reconstruction time with the resealing method is relatively unchanged. As compared to the conventional gridding, reconstruction speed with the resealing method is faster at R<5, but becomes slower at R≧5.

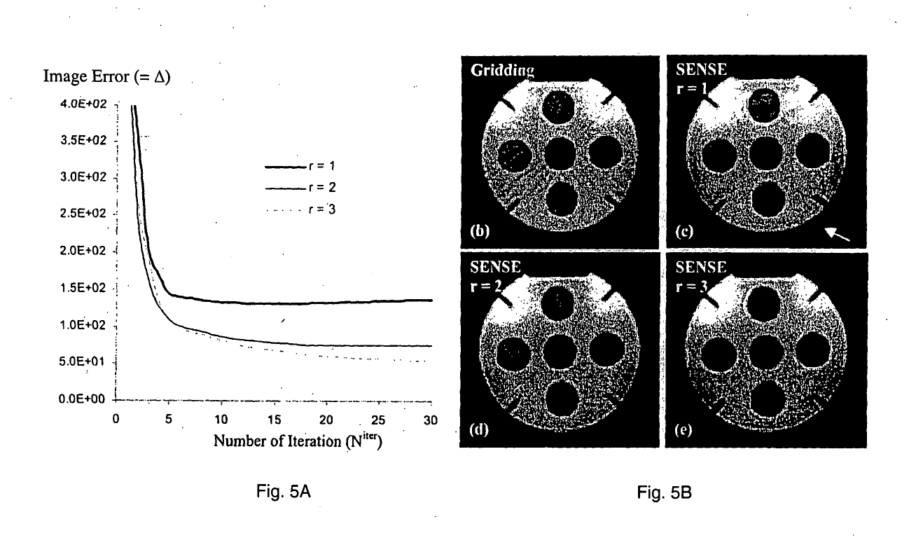

The effect of the resealing factor on SENSE reconstruction is demonstrated in FIGS. 5A-5B. As the number of iterations is increased, image error is decreased 5A). The minimal image error is reduced with the increase of the resealing factor. Conventional gridding reconstruction results in severe streak artifacts with R=3 (image (b) in FIG. 5B). The streak artifacts are substantially reduced by SENSE reconstruction (images (c), (d) and (e) in FIG. 5B), but noise amplification is observed at r=1 (image (c)). Increasing the resealing factor to 2 and 3 reduces noise over the entire image (images (d) and (e)).

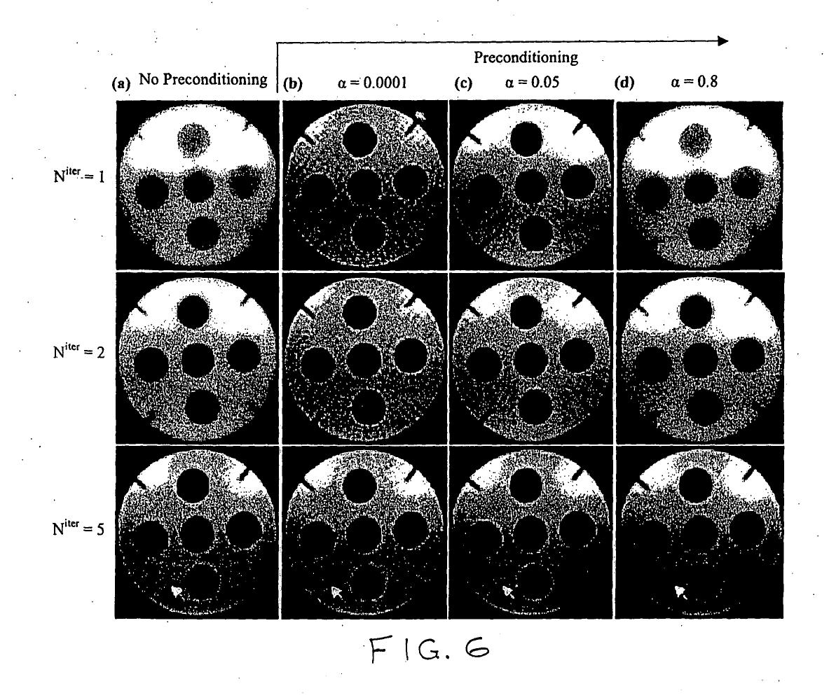

FIG. 6 demonstrates image progression with iterations in SENSE reconstruction using the resealing method with and without preconditioning. When no preconditioning is used, a low spatial resolution image is generated after the first iteration (images (a)). As the iteration progresses, image details are gradually recovered, but streak artifacts become clear at N^{iter}=5. Using the preconditioning with a small α=0.0001, all the images are de-blurred, but severe streak artifacts are observed though they are reduced with iterations (images (b)). When α is increased to 0.05, all the images are de-blurred and streak artifacts are rapidly suppressed (images (c)). Preconditioning with α=0.8 yields the image progression similar to no preconditioning (images (d)).

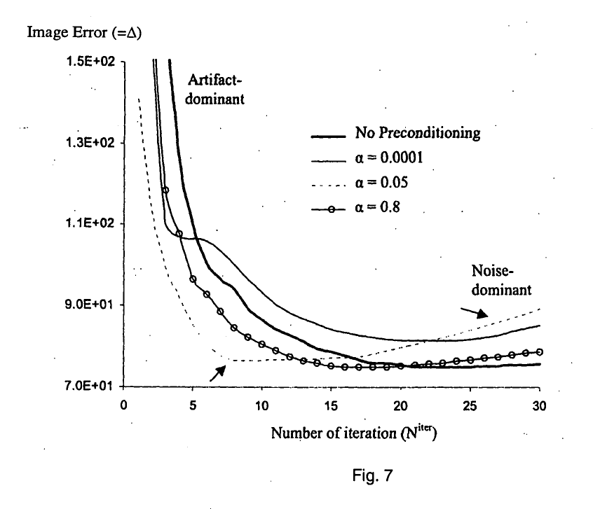

Image errors in SENSE reconstruction using the resealing method are shown with and without preconditioning in FIG. 7. Compared with no preconditioning, preconditioning with α=0.0001 yields more rapid decrease of the image error until N^{iter} reaches 5, but results in a larger, image error at N^{iter}>5. A minimal image error occurs at N^{iter}=22. As α is increased to 0.05, the image error reaches a minimal value at N^{iter}=7, but increases more rapidly after N^{iter}=7.When α rises to 0.8, the curve of image error is moved closer to that with no preconditioning. The number of iterations at which a minimal image error occurs is shifted to N^{iter}=17.

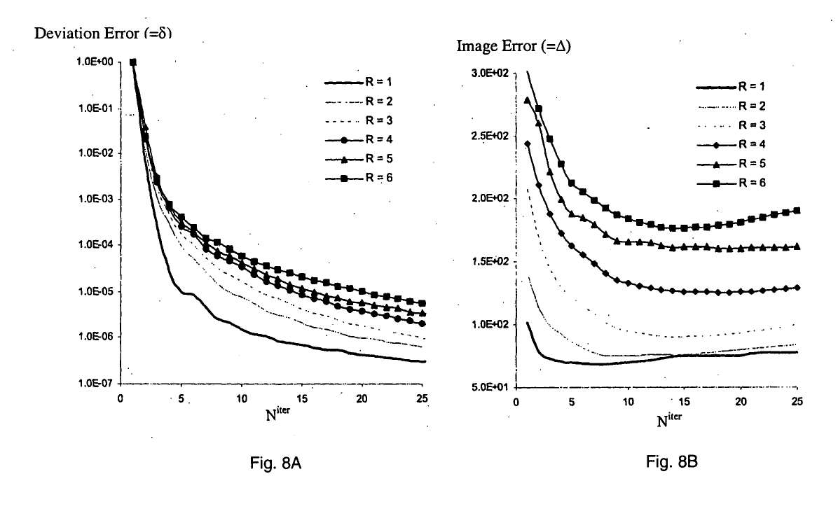

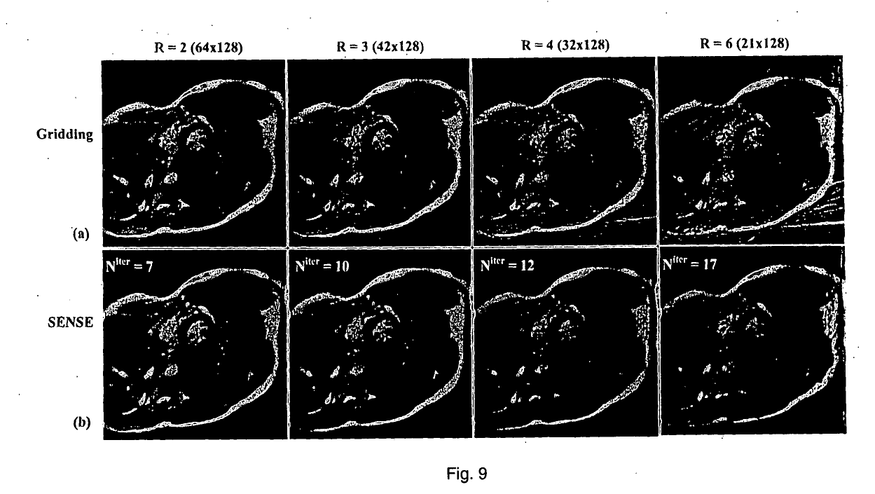

The results of the in vivo experiment are illustrated in FIGS. 8A-8B and 9.

The convergence rate of CGLS SENSE reconstruction with the resealing and preconditioning methods (r=2, α=0.05) is demonstrated in FIGS. 8A and 8B, showing the deviation and image error with increasing R. The deviation error is decreased more rapidly as R is reduced (FIG. 8A). For all the reduction factors, the image error reaches a minimal value at a certain number of iterations and then increases slowly afterwards (FIG. 8B). A large reduction factor increases the image error as well as the number of iterations at which the image error is minimized. Using the image error curve and visual quality of the image, the optimal number of iterations for SENSE reconstruction was estimated to be roughly: 3 for R=1, 6 for R=2, 10 for R=3, 12 for R=4, and 15˜18 for R=5˜6.

The images reconstructed by conventional gridding were compared in FIG. 9 with those generated by the proposed SENSE (r=2, α=0.05) at R=2, 3, 4, and 6. Conventional gridding yields severe streak artifacts over the entire image as R is increased (images (a) in FIG. 9). The streak artifacts are nearly eliminated by SENSE reconstruction with the predetermined optimal number of iterations (images (b) in FIG. 9). The visibly reduced signal-to-noise ratio is observed with increasing R.

The inventive CGLS SENSE reconstruction using both the resealing and preconditioning methods has been successfully performed with radial sampling trajectories. Incorporating the resealing method into CGLS SENSE eliminates the computational complexity of conventional convolution-based gridding and density compensation, accelerating reconstruction speed. The preconditioning speeds up convergence rate of high spatial frequency signals, reducing the number of iterations required for SENSE reconstruction.

As far as reconstruction speed is concerned, the resealing method is well suited to CGLS SENSE because FFT is the only process that is computationally demanding. As the resealing factor is increased, FFT has to deal with a larger size of matrix, decreasing the reconstruction speed. As a result, the reconstruction time in SENSE with the resealing method is highly dependent on the resealing factor, but is nearly independent of the reduction factor as shown in FIG. 4. In the conventional gridding reconstruction, FFT and convolution are the main processes. Compared to the resealing method, FFT takes less time due to a smaller size of matrix. However, convolution operates pixel-by-pixel with density compensation. Computation time therefore is dominated by convolution especially when the reduction factor is small. In addition, conventional CGLS SENSE reconstruction requires the gridding operations twice at each iteration. This explains why the SENSE reconstruction time with conventional gridding is much longer at R<5 as in FIG. 4 than for the resealing method. Further investigation is needed to evaluate the reconstruction speed in clinical scanner.

In the resealing process, artifact and noise may increase due to: 1) signals aliased into a sampled FOV from adjacent replica side-lobes and 2) rounding errors from rescaled sampling trajectories. The rounding errors result from data redundancy in the central region of radial k-space, since several points are mapped onto the same location and averaged with a constant weight. To resolve the problem of the aliased side-lobes, conventional gridding employs over-sampling by a factor of two, which increases the distance between the side-lobes. The same approach can be used in the resealing method by increasing the scaling factor. The data redundancy in the central radial k-space is also decreased as the resealed matrix is expanded. As a result, image quality in SENSE reconstruction is improved by using higher resealing factor as shown in FIGS. 5A-5B, but reconstruction speed slows down due to the increased computational load of FFT. In this work, the rescaling factor of two is estimated to be appropriate for a tradeoff between image quality and computational efficiency. To make the resealing method more efficient, CGLS SENSE may employ several resealing factors increasing with iterations as shown in facilitated iterative next-neighbor regridding approach.

Density compensation was removed over the entire SENSE process, which resulted in image progression from the low to high spatial resolution. Based on this image progression, CGLS SENSE reconstruction can be modeled as an image de-blurring problem to restore image details. Therefore, in this work, an image de-blurring filter is applied to the SENSE reconstruction as preconditioning, accelerating the CGLS convergence rate. In designing the filter, the PSF of E^{H} E operation in Eq. [1] is exploited assuming its spatial invariance. However, the filter is not expected to accurately de-convolve blurring over all the image pixels, since the PSF is spatially varying. The effect of high-pass filtering needs to be limited by adding the additional parameter, α, in Eq. [6]. The very small value of α(≈0.0001) generates a highly oscillating profile in the de-blurring filter (FIG. 3B). The filter is then applied to all image pixels with a constant weight, amplifying artifact and noise (images (b) in FIG. 6). Convergence rate slows down due to the artifact and noise at the small α. When α rises to a large value (≈0.8) (images (d) in FIG. 6), the effect of high-pass filtering is highly reduced, making the image de-blurring process in CGLS iteration similar to the no preconditioning case (images (a) in FIG. 6). An intermediate value of α≈0.05 is estimated to be optimal, demonstrating the fastest convergence rate with tolerable artifact and noise (images (c) in FIG. 6). The noise increase with iterations is proportional to convergence rate, as shown in FIG. 7. It is therefore important to determine an optimal number of iterations to avoid noise amplification. In accordance with the invention, there are two regularization parameters: the number of iterations and the parameter α of the de-blurring filter. Further studies are needed to optimize these regularization parameters using generalized cross-validation or L-curve methods.

Compared with a direct inversion method, CGLS iteration provides an efficient implementation for SENSE reconstruction, but has a disadvantage in the speed of its progress toward the desired solution. This behavior is primarily because of the ill conditioned nature of inversion in SENSE reconstruction. The preconditioning in this accordance with the invention can also be understood as a method to improve the condition of inversion. However, as reduction factor is increased, the matrix inversion in SENSE formula becomes more ill conditioned, resulting in decreases of convergence rate as shown in FIGS. 8A and 8B. As a result, the high reduction factors require a large number of iterations to make the high-frequency signals converge sufficiently.

The inventive radial SENSE implementation is efficient because: 1) it eliminates the need of a separate scan for coil calibration using the over-sampled central k-space, 2) it removes the complexity of conventional gridding and density compensation, and 3) the convergence rate in CGLS iteration can be enhanced using a simple image de-blurring method. The inventive method and apparatus to make radial SENSE reconstruction more feasible in clinical scanners with a variety of applications, including dynamic imaging, coronary artery imaging, and functional brain imaging. The benefits of this technique also can be extended to arbitrary k-space trajectories such as spiral and PROPELLER sampling schemes.

Although modifications and changes may be suggested by those skilled in the art, it is the intention of the inventors to embody within the patent warranted hereon all changes and modifications as reasonably and properly come within the scope of their contribution to the art.

We claim as our invention:

1. A method for reconstructing an image from a plurality of sets of magnetic resonance (MR) data, each set of MR data being acquired with a different coil in a plurality of MR reception coils, each set of MR data comprising a k-space matrix in which the MR data are entered along a radial trajectory, said method comprising the steps of:
in a computer, subjecting said sets of MR data to a SENSE preconstruction algorithm, by solving for x, for each of said sets of MR data, E^{H} Ex=E^{H}m, wherein E is an encoding matrix, E^{H} is the Hermitian matrix of E, m is the data set, and x is a data set image, with a predetermined number of CGLS iterations with no convolution of said MR data and no density compensation of said MR data;
in each of said CGLS iterations, resealing each of said k-space matrices to a rectilinearly gridded matrix and forming E^{H} from the rectilinearly gridded matrix, summing the respective data set images to obtain a sum image, passing said sum image through a de-blurring k-space filter to obtain a residual image, separating said residual image into respective restored matrices for said coils with said radial trajectory restored, and forming E from said restored matrices; and
after a last of said predetermined number of CGLS iterations, extracting a region of interest from the residual image from said last CGLS iteration.

2. A method as claimed in claim 1 wherein each of said coils has a coil sensitivity, and comprising forming E in each of said CGLS iterations by multiplying the residual image by the respective sensitivities to obtain a plurality of intermediate data sets, and subjecting each of said intermediate data sets to a fast Fourier transformation.

3. A method as claimed in claim 2 wherein each fast Fourier transformation of the respective intermediate data sets produces a transformation result, and comprising forming E by applying a k-space mask to each of said transformation results to restore said radial k-space trajectory.

4. A method as claimed in claim 3 wherein E comprises a plurality of rescaled data sets, and comprising forming E^{H} by subjecting each of said rescaled data sets to an inverse of said fast Fourier transformation to obtain a plurality of inverse transformed data sets, and subjecting each of said inverse transformed data sets to a region of interest (ROI) mask, comprised of zeros outside of said ROI, to obtain a plurality of further intermediate data sets, and multiplying each of said further intermediate data sets by an inverse of the respective coil sensitivity.

5. A method as claimed in claim 1 comprising, in said computer, generating said de-blurring k-space matrix as a product of a 2D discrete fast Fourier transform matrix, a diagonal matrix containing image de-blurring information, and the complex conjugate of said 2D discrete fast Fourier transform matrix.

6. A method for reconstructing an image from a plurality of sets of magnetic resonance (MR) data, each set of MR data being acquired with a different coil in a plurality of MR reception coils, each set of MR data comprising a k-space matrix in which the MR data are entered along a radial trajectory, said method comprising the steps of:
in a computer, subjecting said sets of MR data to a SENSE reconstruction algorithm with a predetermined number of modified CGLS iterations with no convolution of said MR data and no density compensation of said MR data, each of said CGLS iterations producing a residual image; and
after a last of said predetermined number of CGLS iterations, extracting a region of interest from the residual image from said last CGLS iteration.

7. A magnetic resonance imaging apparatus comprising:
a magnetic resonance (MR) scanner adapted to interact with an examination subject to acquire MR data therefrom, said MR scanner including an RF resonator system comprising a plurality of MR reception coils;
a control unit having a memory in communication therewith, said control unit operating said MR scanner to acquire a plurality of sets of MR data respectively with said plurality of reception coils, each set of MR data being acquired with a different MR reception coil in said plurality of MR reception coils, and said control unit entering the respective sets of MR data with a radial trajectory into respective k-space matrices in said memory; and
an image reconstruction computer that subjects said sets of MR data to a SENSE preconstruction algorithm, by solving for x, for each of said sets of MR data, E^{H}Ex=E^{H} m, wherein E is an encoding matrix, E^{H} is the Hermitian matrix of E, m is the data set, and x is a data set image, with a predetermined number of CGLS iterations with no convolution of said MR data and no density compensation of said MR data, said image reconstruction computer, in each of said CGLS iterations, resealing each of said k-space matrices to a rectilinearly gridded matrix and forming E^{H} from the rectilinearly gridded matrix, summing the respective data set images to obtain a sum image, passing said sum image through a de-blurring k-space filter to obtain a residual image, separating said residual image into respective restored matrices for said coils with said radial trajectory restored, and extracting a region forming E from said restored matrices and, after a last of said predetermined number of CGLS iterations, extracting a region of interest from the residual image from said last CGLS iteration.

8. An apparatus as claimed in claim 7 wherein each of said coils has a coil sensitivity, and comprising forming E in each of said CGLS iterations by multiplying the residual image by the respective sensitivities to obtain a plurality of intermediate data sets, and subjecting each of said intermediate data sets to a fast Fourier transformation

9. An apparatus as claimed in claim 8 wherein each fast Fourier transformation of the respective intermediate data sets produces a transformation result, and comprising forming E by applying a k-space mask to each of said transformation results to restore said radial k-space trajectory.

10. An apparatus as claimed in claim 9 wherein E comprises a plurality of rescaled data sets, and comprising forming E^{H} by subjecting each of said rescaled data sets to an inverse of said fast Fourier transformation to obtain a plurality of inverse transformed data sets, and subjecting each of said inverse transformed data sets to a region of interest (ROI) mask, comprised of zeros outside of said ROI, to obtain a plurality of further intermediate data sets, and multiplying each of said further intermediate data sets by an inverse of the respective coil sensitivity.

11. An apparatus as claimed in claim 10 comprising, in said computer, generating said de-blurring k-space matrix as a product of a 2D discrete fast Fourier transform matrix, a diagonal matrix containing image de-blurring information, and the complex conjugate of said 2D discrete fast Fourier transform matrix.

12. A magnetic resonance imaging apparatus comprising:
a magnetic resonance (MR) scanner adapted to interact with an examination subject to acquire MR data therefrom, said MR scanner including an RF resonator system comprising a plurality of MR reception coils; and
a computer that subjects said sets of MR data to a SENSE reconstruction algorithm with a predetermined number of modified CGLS iterations with no convolution of said MR data and no density compensation of said MR data, each of said CGLS iterations producing a residual image, and that after a last of said predetermined number of CGLS iterations, extracts a region of interest from the residual image from said last CGLS iteration.
